(19) United States
(12) Patent Application Publication
(10) Pub. No.: US 2013/0255724 A1
(43) Pub. Date: Oct. 3, 2013

(54) APPARATUS FOR TREATING SUBSTRATE

(71) Applicant: SEMES CO., LTD., Cheonan-si (KR)

(72) Inventor: Hwan Ik NOH, Cheonan-si (KR)

(73) Assignee: Semes Co., Ltd., Cheonan-si (KR)

(21) Appl. No.: 13/851,360

(22) Filed: Mar. 27, 2013

(30) Foreign Application Priority Data
Mar. 30, 2012 (KR) 10-2012-0033413
Jul. 6, 2012 (KR) 10-2012-0074122

(51) Int. Cl. B08B 3/02

(52) U.S. Cl. CPC B08B 3/024
USPC 134/10; 134/95.2

(57) ABSTRACT

A substrate treating apparatus is provided which includes a treatment container which provides a space in which a substrate is washed; a substrate support member which is included in the space and supports the substrate; a spray member which selectively sprays a plurality of fluids on the substrate seated on the substrate support member. The treatment container comprises a plurality of recovery containers the entrances of which are stacked in an up-and-down direction to receive a fluid within the space; a first elevation member which moves the plurality of recovery containers in an up-and-down direction; and a second elevation member which relatively moves a part of the plurality of recovery containers in an up-and-down direction with respect to the remaining recovery containers.

### CROSS-REFERENCE TO RELATED APPLICATIONS

A claim for priority under 35 U.S.C. §119 is made to Korean Patent Application Nos. 10-201 2-003341 3 filed Mar. 30, 2012 and 10-2012-0074122 filed Jul. 6, 2012, in the Korean Intellectual Property Office, the entire contents of which are hereby incorporated by reference.

### BACKGROUND

The inventive concepts described herein relate to an apparatus and a method capable of performing a cleaning or dry process on a substrate such as a wafer used to manufacture a semiconductor device or a glass substrate used to manufacture a flat panel display.

High-density, high-integration, and high-performance semiconductor devices may cause rapid scale-down of circuit patterns. As circuit patterns are rapidly scaled down, contamination substances (e.g., particles, organic contaminants, metal contaminants, etc.) remaining on a substrate surface may influence characteristics of devices and a yield. For this reason, a cleaning process for removing various contamination substances attached on a substrate surface may be inevitably required at a semiconductor manufacturing process. The substrate cleaning process may be performed before and after unit processes executed to manufacture a semiconductor device.

Fume may be generated from a fluid when a substrate is processed using the fluid. The fume may exist at the periphery of the substrate treating apparatus to function as a source of a contaminant substrate.

### SUMMARY

One aspect of embodiments of the inventive concept is directed to provide a substrate treating apparatus comprising a treatment container which provides a space in which a substrate is washed; a substrate support member which is included in the space and supports the substrate; a spray member which selectively sprays a plurality of fluids on the substrate seated on the substrate support member. The treatment container comprises a plurality of recovery containers the entrances of which are stacked in an up-and-down direction to receive a fluid within the space; a first elevation member which moves the plurality of recovery containers in an up-and-down direction; and a second elevation member which relatively moves a part of the plurality of recovery containers in an up-and-down direction with respect to the remaining recovery containers.

In example embodiments, the plurality of recovery containers comprises one or more fixing recovery containers provided so that a relative position to a frame is fixed; and one or more transfer recovery containers provided so that relative positions to the fixing recovery containers are moved in an up-and-down direction. The first elevation member is coupled with the frame and the second elevation member is coupled with the transfer recovery containers.

In example embodiments, the entrance of the transfer recovery container is higher in height than that of the fixing recovery container.

In example embodiments, the number of the one or more fixing recovery containers is 3 and the number of the one or more transfer recovery containers is 1.

In example embodiments, the recovery containers are connected with discharge lines, respectively.

In example embodiments, each of the first and second elevation members is formed of a cylinder and the second elevation member is fixed to the first elevation member.

In example embodiments, the first elevation member comprises a first body; a first connection plate provided on the first body and coupled with the frame; and a first cylinder load provided to be moved above and below within the first body and coupled with the first connection plate.

In example embodiments, the second elevation member comprises a second body fixed to the first connection plate; a second connection plate provided on the second body and coupled with the transfer recovery container; and a second cylinder load extended from the inside of the first cylinder load up to the inside of the second body and provided to be moved in an up-and-down direction within the first cylinder and the second body.

One aspect of embodiments of the inventive concept is directed to provide a substrate cleaning method comprising seating a substrate on a substrate support member; supplying chemical on the substrate; supplying a cleaning solution on the substrate; and supplying a fluid for dry on the substrate. The fluid for dry is recovered through a transfer recovery container and the chemical is recovered through a fixing recovery container.

In example embodiments, in supplying a fluid for dry on the substrate, an entrance of the transfer recovery container is opened, and in supplying chemical on the substrate, the entrance of the transfer recovery container is closed.

In example embodiments, while an entrance of the transfer recovery container is opened, an entrance of the fixing recovery container is opened.

In example embodiments, the fixing recovery container is provided in plurality and chemical, generating a relative lot of fume, from among chemicals is recovered through a fixing recovery container having an entrance disposed at the lowermost position.

With embodiments of the inventive concept, it is possible to suppress fume generated at a fluid treating process from being discharged to the exterior. Also, it is possible to prevent a transfer recovery container from be contaminated by fume generated at a fluid treating process. Further, it is possible to minimize such a phenomenon that a fluid supplied to a substrate is spattered to the outside of a container.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a plan view of a substrate treating system according to an embodiment of the inventive concept.

FIG. 2 is a plan view of a substrate treating apparatus.

FIG. 3 is a sectional view of a substrate treating apparatus.

FIG. 4 is a diagram illustrating an example in which a transfer recovery container of a treatment container in a substrate treating apparatus of the inventive concept is opened.

FIG. 5 is a diagram illustrating an example in which a transfer recovery container of a treatment container in a substrate treating apparatus of the inventive concept is opened.

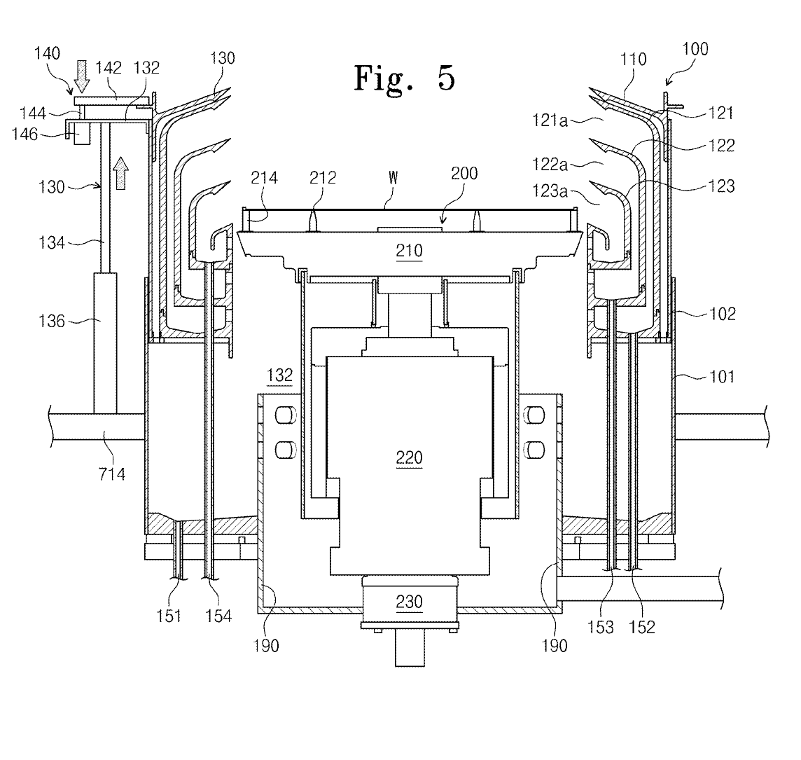

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features.

Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

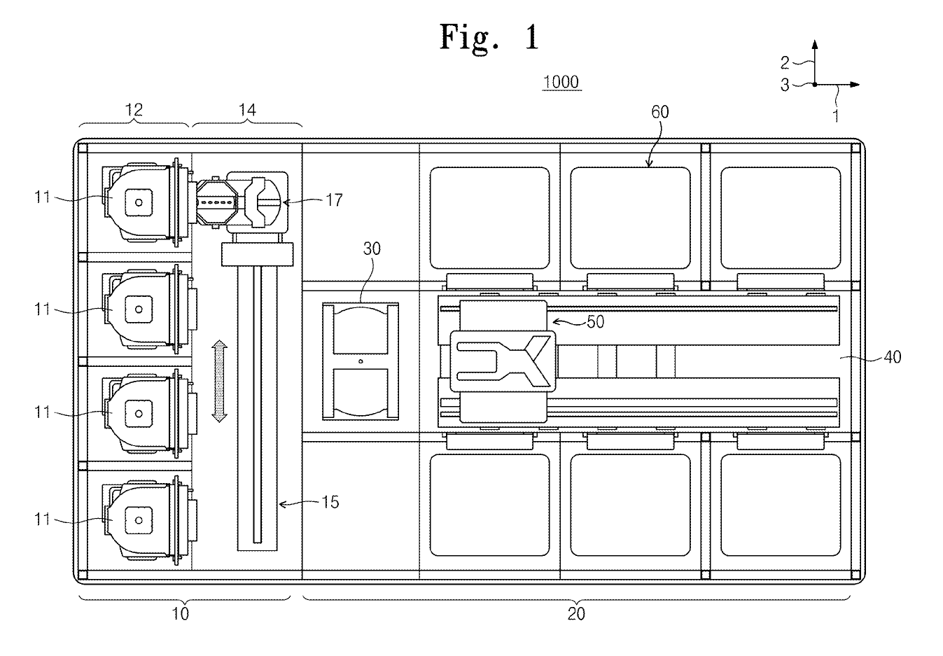

FIG. 1 is a plan view of a substrate treating system according to an embodiment of the inventive concept.

Referring to FIG. 1, a substrate treating system 1000 of the inventive concept may include an index unit 10 and a process treating unit 20. The index unit 10 and the process treating unit 20 may be disposed in a line. Below, an arranged direction of the index unit 10 and the process treating unit 20 may be referred to as a first direction 1. When viewed from an upper side, a direction perpendicular to the first direction 1 may be referred to as a second direction 2. A direction perpendicular to a plane including the first and second directions 1 and 2 may be referred to as a third direction 3.

The index unit 10 may be disposed at a front of the first direction 1 of the substrate treating system 1000. The index unit 10 may include a load port 12 and a transfer frame 14.

A carrier 11 in which a substrate W is received may be seated on the load port 12. If the load port 12 is provided in plurality, the load ports 12 may be disposed in a line along the second direction 2. The number of e load ports 12 may increase or decrease according to a process efficiency and a foot print of the substrate treating apparatus 1000. A front opening unified pod (FOUP) may be used as the carrier 11. A plurality of slots for receiving substrates may be formed at the carrier 11 so that the substrates are disposed to be parallel with a bottom surface.

The transfer frame 14 may be disposed in the first direction 1 to be adjacent to the load port 12. The transfer frame 14 may be disposed between the load port 12 and a buffer unit 30 of the process treating unit 20. The transfer frame 14 may include an index rail 15 and an index robot 17. The index robot 17 may be placed on the index rail 15. The index robot 17 may transfer the substrate W between the buffer unit 30 and the carrier 11. The index robot 17 may do straight movement in the second direction 2 along the index rail 15 or rotate on the third direction 3.

The process treating unit 20 may be disposed at the rear of the substrate treating system 1000 along the first direction 1 to be adjacent to the index unit 10. The process treating unit 20 may include the buffer unit 30, a transfer path 40, a main transfer robot 50, and a substrate treating apparatus 60.

The buffer unit 30 may be disposed at the front of the process treating unit 20 along the first direction 1. The buffer unit 30 may temporarily receive the substrate W before the substrate W is transferred between the substrate treating apparatus 60 and the carrier 11. The buffer unit 30 may include a slot (not shown) on which the substrate W is seated.

If the slot is provided in plurality, the slots may be spaced apart from each other along the third direction 3.

The transfer path 40 may be disposed to correspond to the buffer unit 30. The transfer path 40 may be disposed so that a length direction thereof is provided along the first direction 1. The transfer path 40 may provide a movement path of the main transfer robot 50. The substrate treating apparatuses 60 may be disposed at both sides of the transfer path 40 along the first direction 1 to be opposite to each other. A transfer rail may be installed at the transfer path 40 along the first direction 1. The main transfer robot 50 may move on the transfer rail along the the first direction 1.

The main transfer robot 50 may be installed at the transfer path 40, and may transfer the substrate W between the substrate treating apparatus 60 and the buffer unit 30 or between the substrate treating apparatuses 60. The main transfer robot 50 may do straight movement in the first direction 1 along the transfer path 40 or rotate on the third direction 3.

If the substrate treating apparatus 60 is provided in plurality, the substrate treating apparatuses 60 may be disposed along the first direction 1 at both sides with the transfer path 40 as the center. A part of the substrate treating apparatuses 60 may be disposed along a length direction of the transfer path 40. Also, a part of the substrate treating apparatuses 60 may be disposed to be stacked. That is, the substrate treating apparatuses 60 may be disposed at one side of the transfer path 40 in an ‘A×B’ matrix. Herein, “A” may indicate the number of substrate treating apparatus 60 disposed in a line along the first direction 1, and “B” may indicate the number of substrate treating apparatus 60 disposed in a line along the third direction 3. If four or six substrate treating apparatuses 60 are disposed at one side of the transfer path 40, they may be disposed in a ‘2×2’ or ‘3×2’ matrix. The number of the substrate treating apparatuses 60 may increase or decrease. Unlike the above description, the substrate treating apparatus 60 may be provided at one side and at both sides of the transfer path 40 in a single layer.

The substrate treating apparatus 60 may clean the substrate W. The substrate treating apparatuses 60 may be different structures according to a sort of cleaning process. Unlikely, the substrate treating apparatuses 60 may have the same structure. Selectively, the substrate treating apparatuses 60 may be divided into a plurality of groups. The substrate treating apparatuses 60 in the same group may have the same structure, while the substrate treating apparatuses 60 in different groups may have different structures. For example, in the event that the substrate treating apparatuses 60 are divided into two groups, a first group of substrate treating apparatuses 60 may be disposed at one side of the transfer path 40, and a second group of substrate treating apparatuses 60 may be disposed at the other side of the transfer path 40. Selectively, at both sides of the transfer path 40, a first group of substrate treating apparatuses 60 may be disposed at a lower layer and a second group of substrate treating apparatuses 60 may be disposed at an upper layer. Division of the substrate treating apparatuses 60 into groups may be made according to a chemical sort or a cleaning sort. Unlikely, the first group of substrate treating apparatuses 60 and the second group of substrate treating apparatuses 60 may sequentially perform processes with respect to a substrate W.

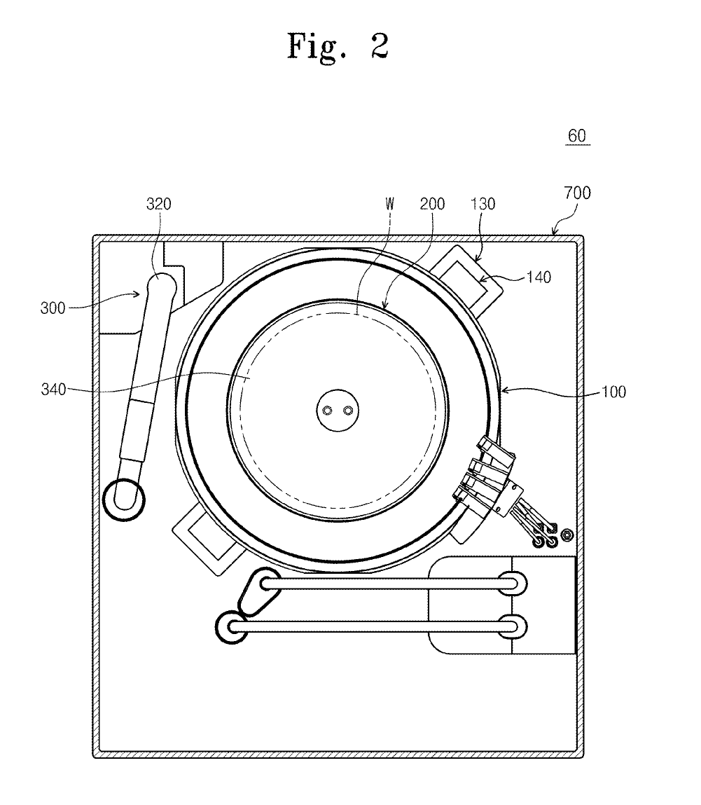

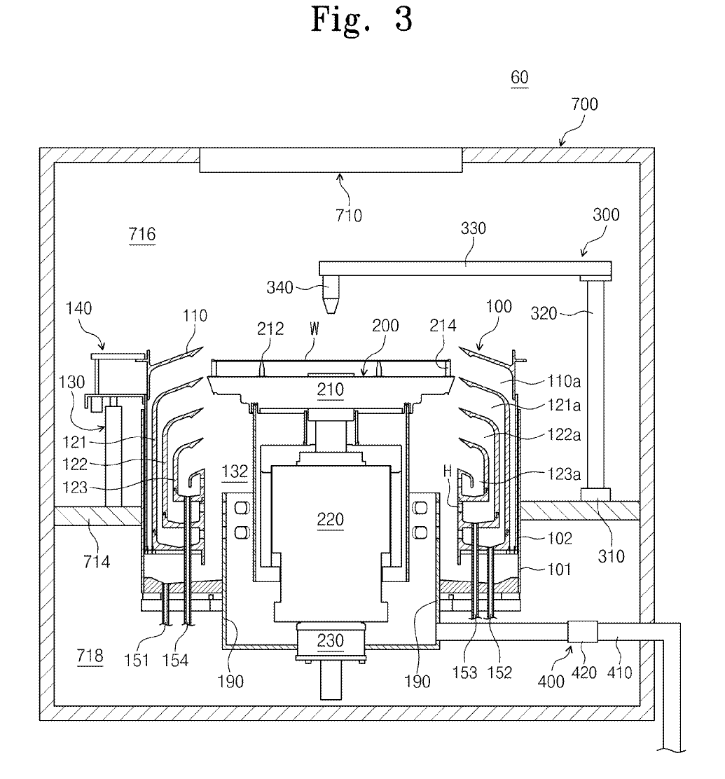

FIG. 2 is a plan view of a substrate treating apparatus. FIG. 3 is a sectional view of a substrate treating apparatus.

Below, there will be described an example of a substrate cleaning apparatus using process fluids such as hot sulfuric acid, alkaline fluid (including O water), acid fluid, rinse fluid, and dry gas (e.g., a gas including IPA). However, the inventive concept is not limited thereto. The inventive concept may be applied all types of apparatuses performing a process (e.g., an etch process) over rotating a substrate.

Also, a semiconductor substrate may be described as a substrate which the substrate treating apparatus 60 processes. However, the inventive concept is not limited thereto. For example, the inventive concept may be applied to various substrates including a glass substrate.

Referring to FIGS. 2 and 3, a substrate treating apparatus 60 may include a process chamber 700, a treatment container 100, a substrate support member 200, a spray member 300 and a discharge member 400.

The process chamber 700 may provide a closed space, and a pan filter unit 710 may be installed at a top of the process chamber 700. The pan filter unit 710 may generate an air pocket within the process chamber 700.

The pan filter unit 710 may be formed of such a module that a filter and an air supply pan are integrated in a unit, and may filter a clean air to supply it within the process chamber 700. The clean air may be supplied in the process chamber 700 passing through the pan filter unit 710 to form an air pocket. The air pocket may provide uniform air current at an upper portion of a substrate, and contamination gas (e.g., fume, etc.) generated at a substrate surface treating process using a process fluid may be discharged to the discharge member 400 through recovery containers of the treatment container 100 together with an air. Thus, it is possible to maintain a cleanliness level of the treatment container 100.

As illustrated in FIG. 2, the process chamber 700 may be divided into an upper region 716 and a lower region 718 by a horizontal partition wall 714. Although schematically illustrated in figure, the lower region 718 may be a maintenance space where recovery lines 151, 152, 153, and 154 connected with the treatment container 100, a sub discharge line 410, a driving unit of a first elevation member, a driving unit connected with a spray nozzle 340 of a spray member 300, a supply line, and the like are disposed. The lower region 718 may be preferably isolated from an upper region where a substrate is processed.

The treatment container 100 may have an opened upper surface and have a cylinder shape. The treatment container 100 may provide a process space for treating a substrate W. The opened upper surface of the treatment container 100 may be used as input and output paths. A substrate support member 200 may be placed within the process space. The treatment container 100 may include a discharge duct 190 connected with the discharge member 400 and disposed under the process space.

The discharge member 400 may be used to provide a discharge pressure within the treatment container at a substrate treating process. The discharge member 400 may include a sub discharge line 410 connected with the discharge duct 190 and a damper 420. The sub discharge line 410 may be supplied with a discharge pressure from a discharge pump (not shown), and may be connected with a main discharge line buried at a bottom space of a semiconductor product line.

The substrate support member 200 may support and rotate the substrate W during a process. The substrate support member 200 may include a spin head 210, a support shaft 212, and a chuck pin 214. The spin head 210 may includea support pin 212, and a chunk pin 214. An upper surface of the spin head 210 may have a circular shape mostly when viewed from an upper side. A support shaft 220 may be fixed to a lower surface of the spin head 210 to be rotated by a rotation driving unit 230.

The support pin 212 may be provided in plurality. The support pins 212 may be disposed at an edge of an upper surface of the spin head 210 to be spaced apart from each other. The support pins 212 may protrude from the spin head 210 in the third direction 3. The support pins 212 may support an edge of a back surface of the substrate W so that the substrate W is spaced apart from the upper surface of the spin head 210. The chuck pin 214 may be provided in plurality. The chunk pins 214 may be disposed at an outer side of the support pins 214 and protrude from the support pins 212 in the third direction 3. The chunk pins 214 may support a lateral portion of the substrate W such that the substrate W does not deviate from a given position in a lateral direction.

A spray member 300 may be supplied with a fluid at a substrate treating process to spray the fluid on a target surface of the substrate seated on the spin head 210 of the substrate support member 200. The spray member 300 may include a support shaft 320, a driver 310, a nozzle support bar 330, and a spray nozzle 340.

A length direction of the support shaft 320 may be provided in the third direction 3. A lower portion of the support shaft 320 may be coupled with the driver 310. The driver 310 may make rotation and straight movement on the support shaft 320. The nozzle support bar 330 may be coupled with the support shaft 320, and may move the spray nozzle 340 to an upper portion of the substrate. Alternatively, the nozzle support bar 330 may move the spray nozzle 340 to an upper portion of the substrate with a fluid being sprayed by the spray nozzle 340.

The spray nozzle 340 may be installed at an end of the nozzle support bar 330. The spray nozzle 340 may be shifted into a process position and a standby position by the driver 310. The process position may be a position where the spray nozzle 340 is disposed on a vertical top of the treatment container 100, and the standby position may be a position where the spray nozzle 340 is disposed outside the vertical top of the treatment container 100. The spray nozzle 340 may spray a fluid supplied from a fluid supply apparatus (not shown). Also, the spray nozzle 340 may be directly supplied through a nozzle with another fluid to be sprayed. The treatment container 100 may include recovery containers 110, 121, 122, and 123, a first elevation member 130, and a second elevation member 140.

The recovery containers 110, 121, 122, and 123 may be disposed in multiple stages to receive and inhale a fluid and a gas spattered from the substrate rotating. The recovery containers 110, 121, 122, and 123 may be divided into a transfer recovery container 110 placed at the uppermost stage and first to third fixing recovery containers 121, 122, and 123 sequentially placed under the transfer recovery container 110. The recovery containers 110, 121, 122, and 123 may recover different process fluids used during a process.

The third fixing recovery container 123 may have a ring shape to surround the substrate support member 311. The second fixing recovery container 122 may have a ring shape to surround the third fixing recovery container 123. The first fixing recovery container 121 may have a ring shape to surround the second fixing recovery container 122. The transfer recovery container 110 may have a ring shape to surround a part of an upper portion of the first fixing recovery container 121. An inner space 123a of the third fixing recovery container 123 may be used as an inflow path through which a fluid and a gas are provided within the third fixing recovery container 123. A space 122a between the third fixing recovery container 123 and the second fixing recovery container 122 may be used as an inflow path through which a fluid and a gas are provided within the second fixing recovery container 122. A space between the second fixing recovery container 122 and the first fixing recovery container 121 may be used as an inflow path through which a fluid and a gas are provided within the first fixing recovery container 121. A space between the first fixing recovery container 121 and the transfer recovery container 110 may be used as an inflow path through which a fluid and a gas are provided within the transfer recovery container 110.

There is illustrated an example in which the treatment container 100 includes three fixing recovery containers. However, the inventive concept is not limited thereto. For example, the treatment container 100 may include two fixing recovery containers or four or more fixing recovery containers.

The recovery containers 110, 121, 122, and 123 may be connected with recovery lines 151, 152, 153, and 154 vertically extended in a downward direction, respectively. The recovery lines 151, 152, 153, and 154 may discharge fluids flowing in through the recovery containers 110, 121, 122, and 123. The fluids discharged may be reused through an external fluid recycling system (not shown).

The first elevation member 130 may make straight movement on the recovery containers in an up-and-down direction. As the recovery containers are moved above and below, a relative height of the treatment container 100 to the first elevation member 130 may be changed. The first elevation member 130 may include a first bracket 132, a second transfer shaft 134, and a first driver 136. The first bracket 132 may be fixed to an outer wall 102 (e.g., a frame) of the treatment container 100. The outer wall 102 may be installed at an inner side of a cylinder base 101 of the treatment container 100 to be moved above and below. The fixing recovery containers 121, 122, and 123 may be fixed to the outer wall 102, and the transfer recovery container 110 may be installed at an upper portion of the outer wall 102 to be moved above and below. A first transfer shaft 134 may be fixed to the first bracket 132 to be moved above and below by the first driver 136. When the substrate W is seated on the spin head 200 or picked up from the spin head 200, the recovery containers may descend so that the spin head 200 protrudes to an upper portion of the treatment container 100. Also, heights of the recovery containers may be adjusted so that a fluid flows in a predetermined recovery container according to a sort of fluid supplied to the substrate W during a process. The first driver may be a cylinder apparatus, and the first transfer shaft may be a cylinder load moved above and below within the first driver.

A second elevation member 140 may rectilinearly move the transfer recovery container in an up-and-down direction. The second elevation member 140 may include a second bracket 142, a second transfer shaft 144, and a second driver 146. The second bracket 142 may be installed at the transfer recovery container, and the second transfer shaft 144 may be fixed to the second bracket 142 to be moved in an up-and-down direction by the second driver 146. The second driver 146 may be installed at the first bracket 132. The second driver 146 may be a cylinder apparatus, and the second transfer shaft may be a cylinder load moved above and below in the second driver. There is illustrated a cylinder type of elevation member. However, various rectilinear driving apparatuses may be used.

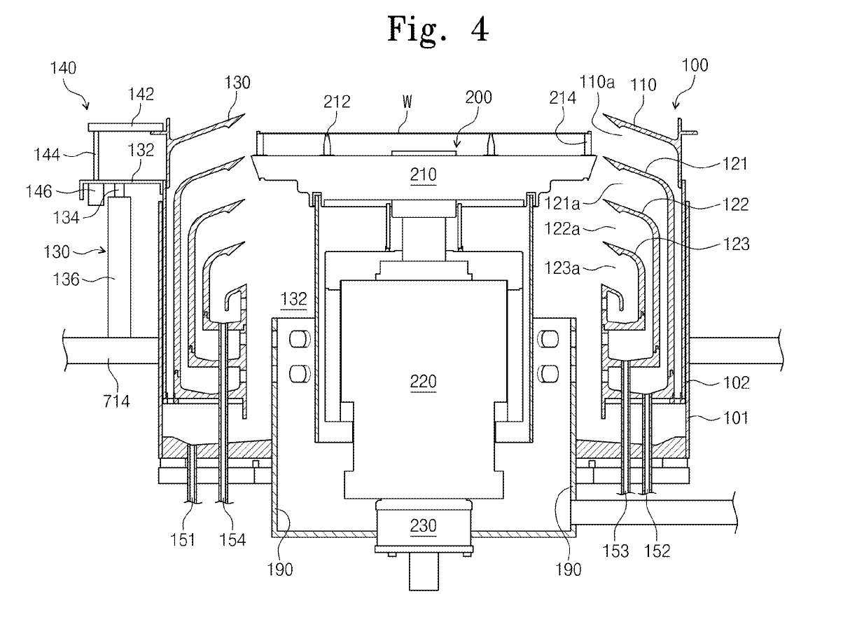

The above-described substrate treating apparatus 60 may use the transfer recovery container 110 at the following process step. The substrate treating apparatus 60 may perform rinse-dry treatment under the condition that the transfer recovery container 110 is elevated (opened) from a “0-stage” position where a height of the treatment container 100 is at an initial stage (refer to FIG. 4). When a substrate is treated using a fluid generating a lot of fume and having strong spattering by a chemical reaction, the substrate treating apparatus 60 may elevate the transfer recovery container 110 so that spattering of the fluid to the outside of the treatment container 100 is minimized. Also, the substrate treating apparatus 60 may open the transfer recovery container 110 at a rinse-dry process and close it when a substrate is treated using a fluid having a strong contamination property. Thus, it is possible to prevent an inner wall of the transfer recovery container 110 from being contaminated.

Below, a substrate cleaning method using the substrate cleaning apparatus according to the inventive concept will be described.

The substrate cleaning method may include a substrate loading step, a substrate cleaning step, a substrate dry step, and a substrate unloading step.

In the substrate loading step, a substrate may be loaded on a substrate support member 200. In the substrate cleaning step, the substrate may be washed by a cleaning solution. In the substrate dry step, the substrate may be dried by supplying a fluid for dry to the washed substrate. In the substrate unloading step, the dried substrate may be unloaded from the substrate support member 200.

The substrate cleaning step may include supplying chemical on the substrate, supplying a cleaning fluid on the substrate, and supplying a fluid for dry on the substrate. The fluid for dry may be recovered through the transfer recovery container 110, and the chemical may be recovered through one of fixing recovery containers 121, 122, and 123.

In supplying a fluid for dry on the substrate, an entrance of the transfer recovery container 110 may be opened. In supplying chemical on the substrate, an entrance of the transfer recovery container 110 may be closed. While an entrance of the transfer recovery container 110 is opened, entrances of the fixing recovery containers 121, 122, and 123 may be closed. Chemical generating a lot of fume may be recovered by the third fixing recovery container 123 the entrance of which is disposed at the lowermost position.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A substrate treating apparatus comprising:
a treatment container which provides a space in which a substrate is washed;
a substrate support member which is included in the space and supports the substrate;
a spray member which selectively sprays a plurality of fluids on the substrate seated on the substrate support member,
wherein the treatment container comprises:
a plurality of recovery containers the entrances of which are stacked in an up-and-down direction to receive a fluid within the space;
a first elevation member which moves the plurality of recovery containers in an up-and-down direction; and
a second elevation member which relatively moves a part of the plurality of recovery containers in an up-and-down direction with respect to the remaining recovery containers.

2. The substrate treating apparatus of claim 1, wherein the plurality of recovery containers comprises:
one or more fixing recovery containers provided so that a relative position to a frame is fixed; and
one or more transfer recovery containers provided so that relative positions to the fixing recovery containers are moved in an up-and-down direction, and
wherein the first elevation member is coupled with the frame and the second elevation member is coupled with the transfer recovery containers.

3. The substrate treating apparatus of claim 2, wherein the entrance of the transfer recovery container is higher in height than that of the fixing recovery container.

4. The substrate treating apparatus of claim 2, wherein the number of the one or more fixing recovery containers is 3 and the number of the one or more transfer recovery containers is 1.

5. The substrate treating apparatus of claim 4, wherein the recovery containers are connected with discharge lines, respectively.

6. The substrate treating apparatus of claim 1, wherein each of the first and second elevation members is formed of a cylinder and the second elevation member is fixed to the first elevation member.

7. The substrate treating apparatus of claim 6, wherein the first elevation member comprises:
a first body;
a first connection plate provided on the first body and coupled with the frame; and
a first cylinder load provided to be moved above and below within the first body and coupled with the first connection plate.

8. The substrate treating apparatus of claim 7, wherein the second elevation member comprises:
a second body fixed to the first connection plate;
a second connection plate provided on the second body and coupled with the transfer recovery container; and
a second cylinder load extended from the inside of the first cylinder load up to the inside of the second body and provided to be moved in an up-and-down direction within the first cylinder and the second body.

9. A substrate cleaning method comprising:
seating a substrate on a substrate support member;
supplying chemical on the substrate;
supplying a cleaning solution on the substrate; and
supplying a fluid for dry on the substrate,
wherein the fluid for dry is recovered through a transfer recovery container and the chemical is recovered through a fixing recovery container.

10. The substrate cleaning method of claim 9, wherein in supplying a fluid for dry on the substrate, an entrance of the transfer recovery container is opened, and in supplying chemical on the substrate, the entrance of the transfer recovery container is closed.

11. The substrate cleaning method of claim 9, wherein while an entrance of the transfer recovery container is opened, an entrance of the fixing recovery container is opened.

12. The substrate cleaning method of claim 9, wherein the fixing recovery container is provided in plurality and chemical, generating a relative lot of fume, from among chemicals is recovered through a fixing recovery container having an entrance disposed at the lowermost position.
